(19) United States
(12) Patent Application Publication
(10) Pub. No.: US 2016/0347973 A1
(43) Pub. Date: Dec. 1, 2016

(54) ADHESIVE TAPE

(71) Applicant: TESA SE, Norderstedt (DE)

(72) Inventors: Frank LANGE, Hamburg (DE); Tanja URBAN, Hamburg (DE)

(21) Appl. No.: 15/117,577

(22) PCT Filed: Feb. 9, 2015
(86) PCT No.: PCT/EP2015/052589

§ 371 Date: Aug. 9, 2016

(30) Foreign Application Priority Data
Feb. 10, 2014 (DE) 10 2014 202 346.7

(51) Int. Cl. C09J 7/02; C09J 5/00; C09J 107/00

(52) U.S. Cl. CPC C09J 7/0275; C09J 7/0228; C09J 107/00; C09J 5/00; C09J 2407/00; C09J 2423/106; C09J 2483/005

(57) ABSTRACT

Disclosed is an adhesive tape comprising a carrier consisting of a foil, to one side of which an adhesive substance is applied. The adhesive substance contains a polyisoprene rubber and one or more adhesive resins, the weight ratio of the rubber to the adhesive resin being greater than 1.10. A silicone-based separating agent is applied to the side of the carrier that is not provided with the adhesive substance.

This application is a §371 U.S. National stage of PCT International Patent Application No. PCT/EP2015/052589, filed Feb. 9, 2015, which claims foreign priority benefit of German Patent Application No. DE 10 2014 202 346.7, filed Feb. 10, 2014, the disclosures of each of which patent applications are incorporated herein by reference.

The invention relates to an adhesive tape.

Adhesive strapping tapes so called are suitable particularly for bundling articles. Examples of such articles include pipes, profiles, or stacked cardboard boxes (strapping application).

The strapping applications further include the fastening of moving parts on white goods (such as refrigerators or freezers and air-conditioning units), on red goods such as (gas) ovens, and, generally, on electrical equipment such as printers, for example.

In the technical jargon, the sectors are designated as follows:
Appliance Sector: Fastening of moving parts of refrigerators and freezers and other household appliances such as gas ovens, etc.
Office Automation Sector: Fastening of moving parts of printers, copiers, etc.

Further typical applications for adhesive tapes of these kinds are
a) The temporary fastening of relative large components such as auto windshields, for example, following insertion into the frame until the liquid PU adhesive has cured, to prevent slippage during the curing operation.
b) The endtabbing (end-ply bonding) of metal coils, with the requirement for residue-free redetachability even at low temperatures
c) The temporary sealing of containers or general bonding to surfaces, with the requirement for residue-free redetachability even at low temperatures

The residue-free removability (redetachability) of a (strapping) tape from a variety of substrates is dependent essentially on the peel forces which develop after different periods of time, when the tape is detached from the substrates in question. Ideally, the peel force, in comparison to the initial force, increases only slightly or even not at all, since with increasing peel force there is an increase in the risk either of the carrier tearing or of residues remaining. Hence, in the case of forces that are too high, the film carrier may fail and tear and/or split. Other results of excessively high peel forces may be either the cohesive splitting of the adhesive or else the adhesive failure of the adhesive as a result of detachment from the carrier.

In all cases, unwanted residues of the adhesive tape are produced on the substrate, whether in the form of parts of the tape itself or of parts of the adhesive.

There is, consequently, a need for an adhesive (strapping) tape which can be employed universally across all substrates relevant to the application, examples being plastics ABS, PS, PP, PE, PC and POM, and also various metals, and solventborne, waterborne, and powder-applied coatings and other solvent-free coatings (for example, UV-curing coatings), this tape at the same time bonding securely to these substrates, with sufficiently high bond strengths of, in general, at least 2.5 N/cm, yet nevertheless being removable without residue or damage even after prolonged storage at different temperatures (temperature range: −20° C. to +60° C.) under UV irradiation.

Although adhesive strapping tapes are utilized across a great variety of applications, they have certain key properties allowing them to meet the particular requirements to which they are subject. These properties—without making any claim to completeness—include very high tensile strength (ultimate tensile force), a very good stretch resistance, corresponding to a high modulus at low levels of elongation, and a low elongation at break, a sufficient but not excessive bond strength, a graduated bond strength to the tape's own reverse, residue-free redetachability after the stresses of the application itself, robustness of the carrier with respect to mechanical load, and also, for certain applications, the resistance of the adhesive tape toward UV irradiation and to numerous chemicals.

Whereas some of the properties can be attributed to the adhesive or to other functional layers of the adhesive tape, the stretchability and the tensile strength are based substantially on the physical properties of the carrier material used.

It would be remiss at this point not to mention another disadvantage of the increased bond strengths of adhesive strapping tapes. That disadvantage is that the increase in the bond strengths is accompanied by an increased risk of damaging the substrate on removal, through lifting of paint coatings, for example.

Particularly in the case of rapid removal at acute angles which, while unfavorable, are nevertheless encountered in practice, it is possible that with adhesive (strapping) tapes, even at rate-dependent bond strengths of more than about 10 N/cm, for the adhesive tape carrier to tear in the z-direction and split. At the same time, such bond strengths also impose increased requirements on the effectiveness of the primer and/or on the anchorage of the adhesive on the film carrier, and on the cohesion of the adhesive.

An adhesive tape intended for use as adhesive (strapping) tape ought therefore to exhibit the following properties:
The adhesive tape must secure loose parts during transit; that is, the adhesive tape ought to have a high tear resistance and sufficient bond strengths.
The adhesive tape must not stretch greatly under load; that is, the adhesive tape ought to have high F1-F10% values (high values for the tensile strength at 1% and 10% elongation) or a high modulus of elasticity.
The adhesive tape must function under a variety of climatic conditions; that is, the adhesive tape ought to have a climatic resistance in the temperature range between −20° C. to 40° C. and a relative humidity of up to 95%.
The adhesive tape ought to be repeelable in the temperature range between −20° C. to 40° C. and a relative humidity of up to 95%; that is, residues as a result of cohesive failure of the adhesive, transfer of adhesive (poor adhesive anchorage), or carrier splitting are not to be observed.
The adhesive tape ought to be easy to use; that is, the adhesive tape ought preferably to have a low unwind force, a feature being ensurable in particular via the use of a carbamate or silicone release.
The adhesive tape ought to bond well to a variety of substrates, and have sufficient cohesion to secure the goods under transit; that is, the adhesive tape may have an adhesive based on natural rubber, SIS rubber, or acrylate.

The prior art encompasses adhesive tapes which are used in the sectors of strapping (bundling), appliance (in-transit securement of movable parts such as drawers, shelves, flaps, particularly in household appliances, etc.) and in the furniture industry and which when used for other applications exhibit weaknesses when the adhesive tape is peeled from the substrate in the lower temperature range (below about 10° C.).

There are primarily two different films which are employed as carrier materials for adhesive strapping tapes:
i) Biaxially oriented PET films having a thickness of between 30 and 60 μm
ii) Monoaxially oriented PP films having a thickness of between 40 and 150 μm

As is known, biaxially oriented PET carriers prove advantageous relative to monoaxially oriented PP (MOPP) carriers by virtue of the greater split resistance at low temperatures, but they do tear earlier in the machine direction (MD; longitudinal direction) than MOPP, and are more expensive and are colorless in their usual market form. Coloring the adhesive tape based on a PET film is accomplished via a subsequent printing operation or by coloring of the adhesive. Monoaxially oriented PP films, on the other hand, are more favorably priced and are easy to color (easily perceptible), this being a general requirement for adhesive tapes which are to be removed again. In application, the high modulus of elasticity and the tensile load for both types of films makes them less stretchable, and therefore highly suitable. MOPP adhesive strapping tapes are used generally for the wrapping of palletized cardboard boxes; the film does not split when detached, because the paper splits readily at the surface. Using MOPP film for adhesive surface-protection tapes has been possible to date only if the adhesion of the adhesive is weak enough to leave neither adhesive nor adhesive-tape remnant with film fraction. The requirement, therefore, is to provide an adhesive tape for surface-protection applications, as for example as in-transit securement for PC printers, refrigerators, electrical and gas ovens or furniture, that has a high adhesion but is residuelessly removable and has these qualities also, in particular, at below usual room temperature—in other words, for example, between −20° C. and +15° C. Falling temperature is accompanied by a drop in the toughness of a polypropylene film and at the same time by an increase in the bond strength of the adhesive. The challenge is to minimize this low-temperature behavior and, through a suitable combination of film and adhesive, to find a solution which achieves the technical object.

For the functionality of the adhesive tape, extremely good internal strength at low temperatures on the part of the carrier used, and the choice of a suitable adhesive, are greatly important. On the one hand, the adhesive must permit secure bonding, meaning that the bond strengths on the various substrates must not fall below a certain level. On the other hand, the residue-free redetachability of the adhesive tapes from the different substrates is an absolute necessity, meaning that the adhesive, when peeled off, must not undergo cohesive failure, must not leave deposits behind, and must not cause splitting or tearing of the adhesive tape as a result of excessive peel increase.

Existing adhesives not optimized for low-temperature redetachability in some cases cause the carrier of the adhesive tape to split or tear if peeled under cold conditions. These adhesives often possess a dynamic T_{g} which is above the in some cases very low application temperatures under which the adhesive tape is to be peeled away.

Release agents are coating materials which prevent or reduce the adhesion to a material. The layer applied to the reverse of adhesive tape carriers, for example, is termed a release agent. This layer enhances the unwind performance of the adhesive tape wound into a roll, reducing the unwind forces relative to an unfurnished carrier.

Known release agents include silicone, fluorinated silicone, silicone copolymers, waxes, carbamates, or mixtures of two or more of the substances stated.

For single-sided adhesive tapes such as adhesive strapping tapes, carbamate varnishes and silicone varnishes are generally the release used.

Carbamate varnishes have no significant effect on the adhesive properties.

It is an object of the invention to obtain a marked improvement over the prior art and to provide an adhesive tape which exhibits reduced splitting when the adhesive tape is peeled off under cold conditions in a temperature range between −20° C. and up to +15° C., the intention being more particularly to improve the low-temperature split resistance in cross- and z-directions when the carrier is loaded suddenly.

This object is achieved by an adhesive tape as described herein. Advantageous embodiments of the invention are also described herein. Likewise embraced is the a method for using the adhesive tape of the invention.

The invention accordingly relates to an adhesive tape having a carrier composed of a film carrying on one side an applied adhesive, where the adhesive comprises a polyisoprene rubber and one or more tackifier resins, the rubber/tackifier resin weight ratio being greater than 1.10, and the side of the carrier not furnished with adhesive carries an applied, silicone-based release agent.

Suitable carrier material for the adhesive tape includes films such as, for example, BOPP, MOPP, PP, PE, polyesters such as PET, PA, PU, PVC, film laminates, foams, and foamed or metallized films. The films themselves may consist in turn of a plurality of individual plies, as for example of plies which are coextruded to form a film.

Preferred film materials are polyolefins, although copolymers of ethylene and polar monomers such as styrene, vinyl acetate, methyl methacrylate, butyl acrylate or acrylic acid are also included. The material may be a homopolymer such as HDPE, LDPE, MDPE, or a copolymer of ethylene and a further olefin such as propene, butene, hexene or octene (for example, LLDPE, VLDPE). Also suitable are polypropylenes (polypropylene homopolymers, random polypropylene copolymers, or block polypropylene copolymers, for example).

Outstandingly useful as films in accordance with the invention are monoaxially and biaxially oriented films. Monoaxially oriented polypropylene is notable for its very high tear strength and low stretch in machine direction and is used, for example, for producing strapping tapes.

Particularly preferred are films based on polyester, preferably polyethylene terephthalate, or, in particular, on polypropylene.

According to one preferred embodiment, the carrier consists of a film which is a monoaxially oriented film which consists to an extent of at least 50 wt % of a polypropylene homopolymer and to an extent of 10 to 25 wt %, preferably 12 to 20 wt %, more preferably 15 wt %, of a copolymer of ethylene and 2 to 6 mol % of an α-olefin, the α-olefin of the copolymer being a diene having at least four carbon atoms and being preferably selected from the group of butene, hexene and/or octene.

Employed preferably as polypropylene homopolymer are pellets whose only polymer is polypropylene.

The polypropylene homopolymer may also be used in the form of a polypropylene reactor blend. The production of such reactor blends is described in EP 0 808 870 A1, EP 0 877 039 A1 and M. Pires et al., J. Appl. Poly. Sci. vol. 92, pp. 2155 to 2162 (2004). They consist of a finely divided mixture, formed during the polymerization, of a polypropylene homopolymer and of a substantially amorphous ethylene-propylene copolymer (EPR, ethylene propylene rubber).

A reactor blend with a high EPR copolymer fraction, i.e., with a fraction of 5 to 12 wt % (meaning that the flexural modulus of the raw material or the modulus of elasticity of the film are less than 1250 MPa), produces flexible films when blended with a copolymer of ethylene and octene.

In one preferred embodiment the film includes not only the pure polypropylene homopolymer and the copolymer of ethylene and octene but also, as a third polymer component, a polypropylene reactor blend. The compatibility of polypropylene and polyethylene is limited (meaning that the adhesion of the two phases to one another is poor), and a reactor blend in the polymer mixture of the invention may therefore act as a compatibilizer and so enhance the mechanical properties.

One particularly preferred film comprises 55 to 80 wt % of a polypropylene homopolymer, 10 to 25 wt % (preferably 15 wt %) of a copolymer of ethylene and octene in accordance with the invention, and 10 to 20 wt % (preferably 15 wt %) of an EPR. Besides the principal constituents according to the invention, the EPR may also be added as an independent raw material; examples of trade names are Vistamaxx® and Versify®.

Another particularly preferred film comprises 75 to 90 wt % of a polypropylene impact copolymer, 10 to 25 wt % (preferably 15 wt %) of a copolymer of ethylene and octene in accordance with the invention.

On account of the more uniform distribution in the film, the EPR is preferably used as part of a polypropylene reactor blend. Also suitable as compatibilizers for the principal components according to the invention are random polypropylene copolymers, though they are more disadvantageous in the context of coating with the adhesive, on account of their lower heat stability. For this reason, the film of the invention also consists substantially of a homopolymer or of a polypropylene impact copolymer and not of a random copolymer. The melt index of the polypropylene of the invention (230° C.) is preferably in the range from 0.5 to 5 dg/min (g/10 min) and crystallite melting point is at least 158° C. and the flexural modulus is preferably at least 1400 MPa. The copolymer of ethylene and octene preferably has a melt index of 0.5 to 5 dg/min (190° C.) and preferably a density of 0.895 to 0.925 g/cm³.

The ethylene copolymer may also be an α-olefin having four, five, six, seven, nine or more carbon atoms. The α-olefin of the copolymer is not, however, propylene (having three carbon atoms), since such mixtures lead to carrier splitting on peel removal, presumably on account of the significantly higher glass transition temperature than the copolymers of the invention.

The film may also be admixed with coloring masterbatches based on PE and PP, such as PM2979E4 from Techmer PM, for example. Masterbatches or color granules are plastics additives in the form of granules, containing colorants or additives at levels higher than in the end application. They are admixed to the natural plastic (crude polymer) for coloring or for modifying the properties. In comparison to pastes, powders, or liquid adjuvants, masterbatches increase operational reliability and have very good processing qualities.

The film of the adhesive tape of the invention is obtained by extrusion and stretching in machine direction using customary methods which are general knowledge. The films may be unstretched.

The film may be colored and/or transparent.

The draw ratio on orientation of the extruded primary film in machine direction (longitudinal direction) is preferably 1:5 to 1:9, more preferably 1:6 to 1:7.5, very preferably 1:6 to 1:6.5. A 1:6 draw ratio indicates that from a section of the film with a length, for example, of 1 m, a section 6 m in length of the oriented film is produced. Orientation takes place without any substantial reduction in the width of the primary film, only at the extents of the thickness of the film.

The customary film thickness after orientation is between 40 and 150 μm. Preference is given to 50 to 100 μm.

In general there is at least one corona pretreatment or else flame pretreatment of the side of the film carrier that is intended for subsequent coating with the adhesive, in order to anchor the adhesive more effectively on the carrier. Another improvement in adhesion synonymous with the anchorage of the adhesive on the carrier may be accomplished through the use of primers. With these it is possible first to targetedly adjust the surface energy and second, when using isocyanate-containing primers, for example, to pursue chemical attachment of the elastomeric adhesive component to the carrier.

The customary weight per unit area at which the primer is applied is between 0.1 and 10 g/m². Another means of enhancing the anchorage is to use carrier films which at the premises of the film manufacturer are deliberately equipped, by coextrusion, with a polymer surface favorable for connection to the pressure-sensitive adhesive.

The adhesive comprises a polyisoprene rubber and one or more tackifier resins, the rubber/tackifier resin weight ratio being greater than 1.10. Advantageously the rubber/tackifier resin weight ratio is between 1.10 and 1.60, preferably between 1.30 and 1.50. A preferred polyisoprene rubber is natural rubber. Its Mooney viscosity (conditions 1+4, 125° C.) is preferably between 50 and 110, more preferably between 55 and 75, more preferably 75.

In one advantageous embodiment the adhesive consists only of rubber and tackifier resins, more preferably only of rubber and tackifier resins with the addition of up to 20 wt % (based on the overall composition) of aging inhibitors.

According to a further preferred embodiment of the invention, the adhesive consists only of polyisoprene rubber as elastomer component, more preferably only of natural rubber to which (besides the tackifier resins) the customary and known additives may be added.

Preference is given to using an adhesive whose elastomer consists of the group of the natural rubbers or of a blend of natural rubbers and/or synthetic rubbers, the fraction of the synthetic rubber in the blend, according to one preferred variant, being no greater at most than the fraction of the natural rubber.

The natural rubber or natural rubbers may be selected in principle from all available grades such as, for example, crepe, RSS, ADS, TSR or CV types, according to the requisite levels of purity and of viscosity, and the synthetic rubber or synthetic rubbers may be selected from the group of the randomly copolymerized styrene-butadiene rubbers (SBR), the butadiene rubbers (BR), the synthetic polyisoprenes (IR), the butyl rubbers (IIR), the halogenated butyl rubbers (XIIR), the acrylate rubbers (ACM), the ethylene-vinyl acetate copolymers (EVA) and the polyurethanes, and/or blends thereof.

With further preference the rubbers may be admixed, for the purpose of improving their processing properties, with thermoplastic elastomers in a weight fraction of 10 to 20 wt %, based on the overall elastomer fraction.

Representatively at this point, mention may be made in particular of the especially compatible styrene-isoprene-styrene (SIS) and styrene-butadiene-styrene (SBS) types.

Rubber adhesives display a good combination of bond strength, tack, and cohesion, and also balanced adhesive performance on virtually all relevant substrates, and are therefore predestined. General information on rubber adhesives is available in sources including standard works for adhesive tapes, such as the “Handbook of Pressure Sensitive Adhesive Technology”, by Donatas Satas for example.

As tackifier resins it is possible, in the case of the (self-)adhesive, for example, to use as main component, in particular, hydrogenated and unhydrogenated hydrocarbon resins and polyterpene resins. Unhydrogenated hydrocarbon resins and rosin-based tackifier resins may also be used. By using different tackifier resins having different softening points it is possible, in addition to the R/R ratio, to steer an adjustment of the T_{g} via the ratio of resins of high softening point to resins of low softening point.

The term “tackifier resins” is understood by the skilled person to refer to a resin-based substance which increases the tack.

Preferred resins used are C₅ hydrocarbon resins.

As tackifier resins it is possible, in the case of the self-adhesive, for example, to use as main component, in particular, hydrogenated and unhydrogenated hydrocarbon resins and polyterpene resins. Suitable with preference, among others, are hydrogenated polymers of dicyclopentadiene (for example, Escorez 5300 series; Exxon Chemicals), hydrogenated polymers of preferably C₈ and C₉ aromatics (for example, Regalite and Regalrez series; Eastman Inc. or Arkon P series; Arakawa). These may originate through hydrogenation of polymers from pure aromatic streams or else may be based through hydrogenation of polymers based on mixtures of different aromatics. Also suitable are partially hydrogenated polymers of C₈ and C₉ aromatics (for example, Regalite and Regalrez series; Eastman Inc. or Arkon M; Arakawa), hydrogenated polyterpene resins (for example, Clearon M; Yasuhara), hydrogenated C₅/C₉ polymers (for example, ECR-373; Exxon Chemicals), aromatic-modified selectively hydrogenated dicyclopentadiene derivatives (for example, Escorez 5600 series; Exxon Chemicals). The aforesaid tackifying resins may be used both alone and in a mixture.

Hydrogenated hydrocarbon resins are particularly suitable as a blend component for crosslinkable styrene block copolymers, as described in EP 0 447 855 A1, U.S. Pat. No. 4,133,731 A, and U.S. Pat. No. 4,820,746 A, for example, since the absence of double bonds means that crosslinking cannot be disrupted.

Furthermore, however, unhydrogenated resins can also be employed, if crosslinking promoters such as polyfunctional acrylates, for example, are used.

Other unhydrogenated hydrocarbon resins, unhydrogenated analogs of the hydrogenated resins described above, can also be used.

It is possible, moreover, to use rosin-based resins (for example, Foral, Foralyn).

The abovementioned rosins include, for example, natural rosin, polymerized rosin, partially hydrogenated rosin, fully hydrogenated rosin, esterified products of these kinds of rosin (such as glycerol esters, pentaerythritol esters, ethylene glycol esters, and methyl esters), and rosin derivatives (such as disproportionation rosin, fumaric acid-modified rosin, and lime-modified rosin).

The tackifier resins composed of biobased raw materials may be polyterpene resins based on α-pinene and/or β-pinene and/or δ-limone, or terpene-phenolic resins.

Any desired combinations of these can be used in order to adjust the properties of the resultant pressure-sensitive adhesive in accordance with requirements. The depiction of the state of knowledge in the “Handbook of Pressure Sensitive Adhesive Technology” by Donatas Satas (van Nostrand, 1989) may be referenced expressly.

The amount by weight of the resins is at maximum 90.91 (more precisely 100/1.1) phr (that is, per 100 parts by weight of isoprene rubber), preferably 60 to 90 phr.

For the purpose of stabilization, customary adjuvants may be added to the adhesive, such as aging inhibitors (antiozonants, antioxidants, light stabilizers, and so on). Additives for the adhesive that are typically utilized are as follows:
Plasticizing agents such as, for example, plasticizer oils or low molecular mass liquid polymers such as low molecular mass polybutenes, for example
Primary antioxidants such as sterically hindered phenols, for example
Secondary antioxidants such as phosphites or thiosynergists (thioethers), for example
Process stabilizers such as C-radical scavengers, for example
Light stabilizers such as UV absorbers or sterically hindered amines, for example
Processing assistants
Wetting additives
Adhesion promoters
Endblock reinforcer resins and/or
Optionally further polymers preferably elastomeric in nature; elastomers utilizable accordingly include, among others, those based on pure hydrocarbons, as for example unsaturated polydienes such as natural or synthetically generated polyisoprene or polybutadiene, chemically substantially saturated elastomers such as, for example, saturated ethylene-propylene copolymers, δ-olefin copolymers, polyisobutylene, butyl rubber, ethylene-propylene rubber, and also chemically functionalized hydrocarbons such as, for example, halogen-containing, acrylate-containing, allyl or vinyl ether-containing polyolefins
Fillers such as fibers, carbon black, zinc oxide, titanium dioxide, solid microspheres, solid or hollow glass spheres, silica, silicates, chalk.

The substances recited are in turn not mandatory; the adhesive also functions without these substances being added, individually or in any combination, and thus without adjuvants.

The adhesive in conjunction with the stated film permits residue-free removal in the range of the customary application temperature, which is between −20° C. and +40° C.

The customary weight per unit area at which the dry adhesive is applied is between 10 and 50 g/m², preferably between 20 and 40 g/m².

Silicone-based release agent located on the side of the carrier not furnished with adhesive is preferably selected from the group of silicone, fluorinated silicone, silicone copolymers and/or mixtures of two or more of the stated substances.

The release agent may comprise solvent-containing and/or solvent-free systems; preferred are solvent-free systems.

The release agent may be radiation-crosslinking (UV- or electron beam-crosslinking), condensation or addition-crosslinking, preferably it is addition-crosslinking.

Release agents used are preferably crosslinkable silicone systems. These include mixtures of crosslinking catalysts and what are called thermally curable condensation- or addition-crosslinking polysiloxanes. For condensation-crosslinking silicone systems, tin compounds such as dibutyl tin diacetate are frequently present in the composition as crosslinking catalysts.

Silicone-based release agents on an addition-crosslinking basis can be cured by hydrosylylation. These release agents customarily comprise the following constituents:
an alkenylated polydiorganosiloxane (particularly, linear polymers with terminal alkenyl groups),
a polyorganohydrogensiloxane crosslinking agent, and
a hydrosilylation catalyst.

Catalysts established for addition-crosslinking silicone systems (hydrosilylation catalysts) include, for example, platinum or compounds of platinum, such as the Karstedt catalyst (a Pt(0) complex compound), for example.

It is also possible, moreover, for photoactive catalysts, known as photoinitiators, to be used in combination with UV-curable, cationically crosslinking siloxanes based on epoxide and/or on vinyl ether, and/or with UV-curable, radically crosslinking siloxanes such as acrylate-modified siloxanes, for instance. Another possibility is the use of electron beam-curable silicone acrylates. Such systems, depending on intended use, may also include further additions such as stabilizers or flow control assistants. Photopolymerizable organopolysiloxane compositions can also be used. Examples include compositions which are crosslinked through the reaction between organopolysiloxanes which have hydrocarbon radicals substituted by (meth)acrylate groups and bonded directly to the silicon atoms, and in the presence of a photosensitizer (see EP 0 168 713 B1 or DE 38 20 294 C1). Likewise usable are compositions in which the crosslinking reaction is brought about, in the presence of a photosensitizer, between organopolysiloxanes which have mercapto group-substituted hydrocarbon bonded directly to the silicon atoms, and organopolysiloxanes having vinyl groups bonded directly to the silicon atoms. Such compositions are described for example in U.S. Pat. No. 4,725,630 A1. When the organopolysiloxane compositions described for example in DE 33 16 166 C1 are used, which have hydrocarbon radicals substituted by epoxy groups and bonded directly to the silicon atoms, the crosslinking reaction is induced through release of a catalytic amount of acid, obtained by photodecomposition of added onium salt catalysts. Other organopolysiloxane compositions curable by a cationic mechanism are materials which have, for example, propenyloxysiloxane end groups.

Furthermore, fluorinated silicones and/or silicone copolymers may be used.

Employed as release agent in accordance with one preferred embodiment of the invention is an addition-crosslinking silicone system comprising a mixture of or, preferably, consisting of a vinyl-functionalized polysiloxane as base polymer, preferably in a fraction of 92.5 to 99.5 wt %, a methyl hydrogensiloxane as crosslinker, and a platinum catalyst.

Added optionally are so-called MQ resins, as release modifiers and anchorage additives.

Described in particular below are two addition-crosslinking silicone systems, though they are not intended to limit the scope of the systems possible. Optionally it is possible, to the below-specified silicone systems/anchorage to add additives such as HF 86 from Wacker (a vinyl-functionalized epoxysilane) and/or release modifiers known to the skilled person, such as CRA 17 from Wacker (a vinyl-functionalized siloxane with so-called MQ resin structure).

Silicone system A is an addition-crosslinking silicone system from Wacker. 9.751000 g of DEH 9155 (a polydimethylsiloxane functionalized with vinyl groups) are mixed with 0.33022 g of V24 (a methylhydrogenpolysiloxane) and 0.0846 g of Kat OL (a platinum catalyst, also known under the name “Karstedt catalyst”) and 10 g of special-boiling-point spirit (60/95).

Silicone system B is an addition-crosslinking silicone system from MomentiveDow Corning. 9.751000 g of SL 6961 SB 7458 (a polydimethylsiloxane functionalized with vinyl groups) are mixed with 0.33031 g of SL 43307672 (a methylhydrogenpolysiloxane) and 0.8030 g of SL 6210SL 4000 (a platinum catalyst, also known under the name “Karstedt catalyst”) and 10 g of special-boiling-point spirit (60/95).

The release coating is preferably applied with a film thickness of 0.1 to 5.0 μm, more preferably of 0.2 to 2.5 μm, very preferably of 0.43 to 2.0 μm.

The silicone systems are applied from the solution (a mixture of xylene and an aliphatic solvent, preferably special-boiling-point spirit 60/95) and are dried, for example, over 2 min 30 s at 110° C.

The general expression “adhesive tape” for the purposes of this invention embraces all flat structures such as two-dimensionally extended films or film sections, tapes with extended length and limited width, tape sections and the like, and also, lastly, diecuts or labels.

The adhesive tape may be produced in the form of a roll, in other words in the form of an Archimedean spiral wound up onto itself, or else with additional lining on the adhesive side using release materials such as siliconized paper or siliconized film.

Adhesive tapes of the invention are used preferably in the widths of 9 to 50 mm, more particularly 19 to 25 mm, and in that case possess a preferred thickness of 40 to 200 μm, preferably 70 to 180 μm, more preferably 75 to 120 μm.

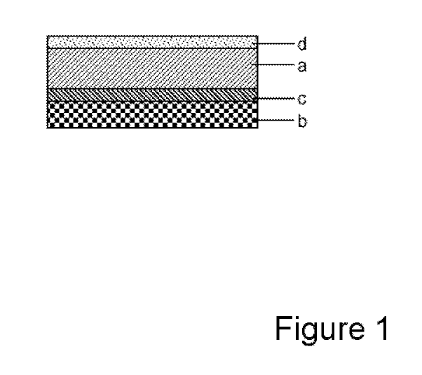

FIG. 1:

FIG. 1 shows a typical construction of the adhesive tape of the invention.

The product consists of a film (a) and an adhesive (b). Additionally there may also be a primer (c) used, for improving the adhesion between adhesive and carrier, and also a reverse-face release (d).

The carrier (a) consists of a monoaxially oriented polypropylene film having a preferred thickness of between 30 and 150 μm.

The adhesive (b) is a mixture of natural rubber or other elastomers and also various resins, and may optionally also include plasticizers, fillers and aging inhibitors. The formula of the adhesive is adjusted such that the elastomer/resin ratio is selected such that the T_{g} of the overall mixture is in the range of the application temperature or even below the minimum application temperature. A further lowering of the T_{g} by means of suitable plasticizers or resins with low T_{g} is possible.

The pressure-sensitive adhesives may be produced and processed from solution, dispersion, and from the melt. Preferred production and processing processes take place from solution and also from the melt. Particularly preferred is the manufacture of the adhesive from the melt, in which case, in particular, batch methods or continuous methods may be employed. The continuous fabrication of the pressure-sensitive adhesives using an extruder is particularly advantageous.

The pressure-sensitive adhesives produced in this way can then be applied to the carrier by the methods which are general knowledge. In the case of processing from the melt, this may involve application methods via a nozzle or via a calender.

In the case of processes from solution, coatings with doctor blades, knives or nozzles are known, to state only a few.

The adhesive tape of the invention exhibits ready redetachability on a wide variety of substrates at temperatures of down to −20° C. On the other hand, however, redetachability exists even at plus temperatures (+40° C.), meaning that no residues are observed as a result of cohesive failure of the adhesive, no instances of adhesive transfer (poor adhesive anchorage), and no carrier splits are observed.

With the combination of rubber-based adhesives and silicone release agent, in accordance with the invention, partial transfer of the silicone from the reverse of the carrier to the adhesive is observed.

EDX measurements (energy dispersive X-ray spectroscopy, EDX, EDRS or EDS), applied to the surface analysis of the adhesive in a stored sample roll, show an S_{I} content of 21 wt %.

This figure, which is very high, suggests relatively low crosslinking of the silicone varnish, allowing the migration of significant fractions of the silicone release agent from the reverse of the carrier to the adhesive located thereon.

In the case of natural rubber adhesives, no significant loss of bond strength is measurable. However, a reduction in the tack can be ascertained.

In the case of acrylate adhesives, and when crosslinking of the silicone is inadequate, silicone varnishes, however, lead to in some cases high depressions of bond strength, as a result of a transfer of the silicone from the coating into the layer of adhesive.

In accordance with the invention, all silicone formulations known to the skilled person can be inventively employed, provided they ensure a suitable transfer of silicone to the adhesive.

On the basis of the properties outlined, the adhesive tape can be employed outstandingly as an adhesive strapping tape for bundling and palletizing cardboard-boxed products and other goods, even at low temperatures.

Furthermore, the adhesive tape can be used for outstanding fastening of moving parts such as doors, flaps and so on printers or refrigerators during transit from the manufacturer to the seller and/or onward to the purchaser, even at low temperatures.

On account of the properties outlined, the adhesive tape of the invention can also be employed advantageously in the following applications:
a) In the temporary fastening of relatively large components such as auto windshields, for example, following insertion into the frame until the liquid PU adhesive has cured, to prevent slippage during the curing operation.
b) In the endtabbing (end-ply bonding) of metal coils, with the requirement for residue-free redetachability even at low temperatures
c) In the temporary sealing of containers or general bonding to surfaces, with the requirement for residue-free redetachability even at low temperatures

Significantly improved splitting of the carrier at low temperatures is observed, and, moreover, the adhesive tapes are redetachable without residue.

The invention is illustrated below by a number of examples, without any intention thereby to impose restrictions on the invention.

All quantity data, fractions, and percent fractions are given by weight “pbw” denotes parts by weight.
Borealis HC600TF PP homopolymer
Braskem PP C154-01Z Impact PP copolymer with a 6 wt % weight fraction of PE and with a 3 wt % weight fraction of an n-heptane-soluble constituent of an ethylene-propylene copolymer (EPR)
Vistamaxx 6102 Ethylene-propylene copolymer, melt index 1.3 g/10 min (190° C./2.16 kg), density 0.862 g/cm³
Engage™ 8150 Copolymer of ethylene and 25 wt % of octene, melt index 0.5 g/10 min (190° C./2.16 kg)
Infuse 9530 Copolymer of ethylene and oct-1-ene, melt index 5 g/10 min (190° C./2.16 kg), density 0.887 g/cm³
Escorez 1102, Exxon Hydrogenated aliphatic HC resin
Escorez 2184, Exxon Aromatically modified aliphatic HC resin
Regalite R1125, Eastman Aliphatic HC resin

### a) Adhesives:

| | Softening point | Adhesive A | Adhesive B |
|---|---|---|---|
| | ASTM E 28 | Concentration | Concentration |
| Component | [° C.] | [wt %] | [wt %] |
| Natural rubber CV 60 | — | 54 | 48 |
| Escorez 1102, Exxon | 100 | 11.5 | 17 |
| Escorez 2184, Exxon | 95 | 11.5 | 17 |
| Regalite R1125, | 120 | 23 | 18 |
| Eastman | | | |

### b) Carrier Films:

### Carrier Film 1 (Carrier A):

73 wt % Borealis HC600TF (PP homopolymer (as per the description))

### 12 wt % Vistamax 6102

### 15 wt % Engage 8150

Via a slot die, a film of in total 620 to 650 μm thickness and 1400 mm width is extruded onto a chill roll. This primary film is supplied via preliminary heating rolls to a roll stretcher of customary construction and is stretched at temperatures of 100 to 135° C. in a ratio of 1:6.5 in machine direction. The film obtained has a thickness of 80 to 85 μm and, after edge trimming, a width of 1200 mm.

The oriented overall film has in machine direction a tensile force at 10% elongation of 40 N/4 mm, a tear force of 85 N/4 mm and an elongation at break of 35%.

A self-adhesive tape is produced from this film.

### Carrier Film 3 (Carrier B):

80 wt % Braskem C-154 (PP impact copolymer)

### 20 wt % Engage 8150

Carrier production as for carrier film 1.

The carrier has a sufficient internal strength in all three directions of space, and has high impact toughness even at low temperatures.

### c) Adhesive Tape:

Applied to one side of the film is the silicone release varnish A of the invention, i.e., the above-described addition-crosslinking silicone system from Wacker. The release substance is applied as a 5% strength solution in xylene, using a roll applicator. The coating thickness (dry) is 0.15 g/m².

Employed as reference is a commercial carbamate varnish from the class of the polyvinylstearylcarbamate with a melting point of between 85 and 110° C. The release substance is applied as a 2% strength solution in toluene, using a roll applicator, and is then dried. The coating thickness (dry) is 0.05 g/m².

Applied to the corona-pretreated surface of the second side of the carrier is a primer conforming to the state of the art.

Applied atop the primer is the pressure-sensitive adhesive A.

The adhesive is applied as a 30% strength solution in mineral spirit with subsequent drying. The application rate of adhesive is 25 g/m². Application from the melt is also possible.

After coating has taken place, the coated carrier webs are converted to rolls 19 mm wide and 66 m long, and wound up, on specialty slitting machines.

| | | | Refer- | | | |
|---|---|---|---|---|---|---|
| | | | ence | Example 1 | Example 2 | Example 3 |
| Carrier | | | A | A | A | B |
| Release | | | Carba- | A | A | A |
| | | | mate | | | |
| Adhesive | | | A | A | A | A |
| Substrate | ABS | −5° C. | 0 | 0 | 0 | 0 |
| | | −10° C. | 10 | 0 | 0 | 0 |
| | | −20° C. | 50 | 0 | 0 | 0 |
| | HIPS | −5° C. | 70 | 0 | 0 | 0 |
| | | −10° C. | 60 | 0 | 0 | 0 |
| | | −20° C. | 40 | 20 | 10 | 20 |
| | GPPS | −5° C. | 20 | 0 | 0 | 0 |
| | | −10° C. | 30 | 0 | 0 | 0 |
| | | −20° C. | 70 | 30 | 10 | 30 |

The table comprehensively sets out the results of different specimens.

### Test Methods

The measurements are carried out (unless indicated otherwise) under test conditions at 23±1° C. and 50±5% relative humidity.

### Bond Strength

The determination of the bond strength (in accordance with AFERA 5001) is carried out as follows: the defined substrate used is galvanized steel sheet with a thickness of 2 mm (obtained from Rocholl GmbH). The bondable sheetlike element under test is cut to a width of 20 mm and a length of about 25 cm, provided with a handling section, and immediately thereafter pressed five times using a 4 kg steel roller, with a rate of advance of 10 m/min, onto the selected substrate. Immediately after that, the bondable sheetlike element is peeled from the substrate at an angle of 180° using a tensile testing instrument (from Zwick) at a rate of v=300 mm/min, and the force needed to achieve this at room temperature is recorded. The measured value (in N/cm) is obtained as the average from three individual measurements.

### Dynamic Glass Transition Temperature

For purely crystalline systems there is a thermal equilibrium between crystal and liquid at the melting point Tₘ. Amorphous or semicrystalline systems, in contrast, are characterized by the transformation of the more or less hard amorphous or semicrystalline phase into a softer (rubberlike to viscous) phase. At the glass transition point, in the case of polymeric systems in particular, there is a “thawing” (or “freezing-in” on cooling) of the Brownian molecular motion of relatively long chain segments.

The transition from the melting point Tₘ (also called “melting temperature”; actually defined only for purely crystalline systems; “polymer crystals”) to the glass transition point T_{g} (also “glass transition temperature”) may therefore be considered to be a fluid transition, depending on the proportion of semicrystallinity in the sample under investigation.

According to its measurement, the glass transition temperature may be reported as a dynamic or as a static glass transition temperature.

The stated dynamic glass transition temperatures in this disclosure relate to the determination by means of dynamic mechanical analysis (DMA) at a low frequency (temperature sweep; measuring frequency: 10 rad/s; temperature range: −35° C. to max. 80° C.; heating rate: 2.5° C./min; rheometric scientific DSR I; parallel plate arrangement, measuring head 200 g air-mounted with standard force; thermal conditioning: Peltier element; sample thickness 1 mm: sample diameter 25 mm: preliminary tensioning with a load of 3N; stress of the specimens for all measurements 2500 Pa).

The glass transition temperature corresponds to the temperature at which the loss factor (tan δ) has its maximum.

### Carrier Splitting

For the measurement, test strips 30 cm long and 20 mm wide are adhered without bubbles to the test face, and are pressed down at a rate of 10 m/min using a rubber-clad 2 kg roller, being over-rolled twice.

The bonded test plates are stored in a heating cabinet (1 d at 43° C.) under defined test conditions, allowing for sufficient wetting of the substrate with the adhesive. Thereafter the test plates are conveyed directly from the drying cabinet into an accessible controlled-climate chamber at −10° C., where they are stored for a further 24 h. After the end of the 24 h, the actual peel test is carried out in the accessible controlled-climate chamber at the particular peeling temperature selected (0° C., −5° C., −10° C., and −20° C.). The adhered adhesive tape strips are peeled from the substrate at a peel angle of, successively, 90° C. and then 180° C. and at a peel speed of initially 0.3 m/min and then 30 m/min.

An evaluation is made of the percentage coverage of the bond area with residues of adhesive tape after the adhesive tape has been peeled off.

Possible changes are, for example, residues of pressure-sensitive adhesive, residues of adhesive tape as a result of carrier splitting, ghosting (i.e., ultrathin tape trace visible, not sticky), discoloration, etc.

### Melt Index “Melt Flow Ratio” (MFR)

The melt index “Melt Flow Ratio” (MFR) is measured according to ISO 1133. For polyethylenes it is determined at 190° C. and with a weight of 2.16 kg, for polypropylenes at a temperature of 230° C.

### Flexural Modulus

The test takes place according to ASTM D 790 A (2% secant).

### Crystallite Melting Point

The crystallite melting point is determined in the usual way in accordance with ISO 3146 by DSC with a heating rate of 10 K/min.

### Density

The density is measured according to ASTM D 792.

### Tackifier Resin Softening Temperature

The tackifier resin softening temperature is carried out according to the relevant methodology, which is known as ring and ball and is standardized in accordance with ASTM E28.

For determining the tackifier resin softening temperature of the resins, a HRB 754 automotive ring & ball unit from Herzog is used. Resin specimens are first of all finely mortared. The resulting powder is introduced into a brass cylinder with an aperture at the base (internal diameter at the upper part of the cylinder 20 mm, diameter of the base aperture of the cylinder 16 mm, cylinder height 6 mm) and melted on a hotplate. The amount induced is selected such that after melting, the resin fully fills the cylinder without protruding.

The resulting sample body, complete with cylinder, is inserted into the sample mount of the HRB 754. Glycerol is used to fill the heating bath, where the tackifier resin softening temperature is between 50° C. and 150° C. For lower tackifier resin softening temperatures, a water bath may also be operated. The test balls have a diameter of 9.5 mm and weigh 3.5 kg. Inline with the HRB 754 procedure, the ball is arranged above the sample body in the heating bath, and is placed down on the sample body. Located 25 mm beneath the base of the cylinder is a collecting plate, which has a light barrier 2 mm above it. During the measuring procedure, the temperature is raised at 5° C./min. Within the temperature range of the tackifier resin softening temperature, the ball begins to move through the base aperture in the cylinder, until finally coming to rest on the collecting plate. In this position, it is detected by the light barrier, and at this point in time the temperature of the heating bath is recorded. A duplicate determination takes place. The tackifier resin softening temperature is the average value from the two individual measurements.

1. An adhesive tape comprising a carrier comprising a film, said adhesive tape having a first and a second side, and an adhesive is applied to the first side, wherein
the adhesive comprises a polyisoprene rubber and one or more tackifier resins,
the rubber:tackifier resin weight ratio is greater than 1.10,
and a silicone-based release agent is applied to the second side.

2. The adhesive tape of claim 1, wherein the film is a monoaxially oriented film which comprises at least 50 wt % of a polypropylene homopolymer and 10 to 25 wt % of a copolymer of ethylene, and 2 to 6 mol % of an α-olefin, the α-olefin being a diene having at least four carbon atoms.

3. The adhesive tape of claim 1, wherein the polypropylene homopolymer comprises granules whose only polymer is polypropylene.

4. The adhesive tape of claim 1, wherein the film comprises 55 to 80 wt % of a polypropylene homopolymer, 10 to 25 wt % of a copolymer of ethylene and 2 to 6 mol % of an α-olefin, and 10 to 20 wt % of an ethylene-propylene rubber (EPR).

5. The adhesive tape of claim 1, wherein a draw ratio on orientation of an extruded primary film in machine direction is 1:5 to 1:9.

6. The adhesive tape of claim 1, wherein a film thickness after orientation is between 40 and 150 μm.

7. The adhesive tape of claim 1, wherein the rubber:tackifier resin weight ratio is between 1.10 and 1.60.

8. The adhesive tape of claim 1, wherein the polyisoprene rubber is a natural rubber.

9. The adhesive tape of claim 1, wherein Mooney viscosity (condition 1+4, 125° C.) of the polyisoprene rubber is between 50 and 110.

10. The adhesive tape of claim 1, wherein the adhesive is made from natural rubbers, or a blend of natural rubbers and synthetic rubbers.

11. The adhesive tape of claim 1, wherein the silicone-based release agent located on the second side is selected from the group consisting of silicone, fluorinated silicone, silicone copolymers and mixtures of two or more of the stated substances.

12. The adhesive tape of claim 1, wherein the silicone-based release agent comprises crosslinkable silicone systems.

13. The adhesive tape of claim 12, wherein the silicone system comprises an addition-crosslinking silicone system comprising a mixture of a polydimethylsiloxane functionalized with vinyl groups, a methylhydrogenpolysiloxane, and a platinum catalyst.

14. The adhesive tape of claim 1, wherein the tackifier resins are resins comprising hydrogenated, partially hydrogenated or unhydrogenated hydrocarbon resins, terpene-phenols, or rosin esters.

15. A method for securing movable parts on printers, copiers, household appliances, electric and gas ovens, and furniture, or for bundling and palletizing cardboard-boxed items, said method comprising a step of applying the adhesive tape of claim 1.

16. (canceled)

17. The adhesive tape of claim 1, wherein the film comprises at least 50 wt % of a polypropylene homopolymer and 15 wt % of a copolymer of ethylene, and 2 to 6 mol % of an α-olefin, the α-olefin being a diene having at least four carbon atoms.

18. The adhesive tape of claim 1, wherein the film comprises at least 50 wt % of a polypropylene homopolymer and 10 to 25 wt % of a copolymer of ethylene, and 2 to 6 mol % of an α-olefin, the α-olefin being a diene selected from the group consisting of butene, hexene and octene.

19. The adhesive tape of claim 5, wherein the draw ratio is 1:6 to 1:7.5.

20. The adhesive tape of claim 6, wherein the film thickness is between 50 and 100 μm.

21. The adhesive tape of claim 47, wherein the rubber:tackifier resin weight ratio is between 1.30 and 1.50.
